(19) United States
(12) Patent Application Publication
(10) Pub. No.: US 2016/0026043 A1
(43) Pub. Date: Jan. 28, 2016

(54) DISPLAY DEVICE

(71) Applicant: Japan Display Inc., Tokyo (JP)

(72) Inventors: Kengo OKAZAKI, Tokyo (JP); Toshiharu MATSUSHIMA, Tokyo (JP)

(21) Appl. No.: 14/803,958

(22) Filed: Jul. 20, 2015

(30) Foreign Application Priority Data
Jul. 25, 2014 (JP) 2014-151971

(51) Int. Cl. G02F 1/1343

(52) U.S. Cl. CPC G02F 1/134336; G02F 2001/134345

(57) ABSTRACT

A liquid crystal display device includes two substrates sandwiching liquid crystals, and first and second electrodes formed in one of the two substrates. The first electrode is one of a pixel electrode and a common electrode. The second electrode is the other of the pixel electrode and the common electrode. The first electrode has, in each pixel, first and second portions extending in a first direction and spaced in a second direction orthogonal to the first direction. The first portion has two opposite edges inclined to the first direction so that the width of the first portion gradually decreases toward one side in the first direction. The second portion has two opposite edges inclined to the first direction so that the width of the second portion gradually increases toward the one side in the first direction.

### CROSS-REFERENCE TO RELATED APPLICATION

The present application claims priority from Japanese patent application JP2014-151971 filed on Jul. 25, 2014, the content of which is hereby incorporated by reference into this application.

### BACKGROUND OF THE INVENTION

1. Field of the Invention

The present invention relates to a liquid crystal display device.

2. Description of the Related Art

Liquid crystal display devices that drive liquid crystals by a horizontal electric field have been used. Some of such liquid crystal display devices have a pixel electrode and a common electrode one of which is comb-shaped. JP 2013-109309 A discloses an electrode that has a plurality of protrusions (portions corresponding to teeth) constituting comb teeth. The protrusions extend side by side in a direction (longitudinal direction in JP 2013-109309 A) of the initial alignment of liquid crystals.

JP 2013-109309 A also discloses an electrode having protrusions with left and right inclined edges so that the width of the protrusions gradually decreases toward the tip. Such an electrode causes liquid crystals near the right side of the protrusions and liquid crystals near the left side of the protrusions to rotate in mutually opposite directions, and thus can improve the drive responsiveness of the liquid crystals, for example, compared with a structure causing liquid crystals in a pixel to rotate in the same direction.

### SUMMARY OF THE INVENTION

In JP 2013-109309 A, all of the protrusions arranged side by side are formed to taper down toward the tip. Thus, liquid crystals near the left edge of the right one of two adjacent protrusions and liquid crystals near the right edge of the left one of the two rotate in mutually opposite directions. Consequently, an area in which liquid crystals do not rotate occurs in the middle between the two adjacent protrusions. Hereinafter, the area is referred to as an ineffective area. For example, for a liquid crystal display device that displays a black image in the initial state, this ineffective area results in a reduction in the light transmittance in displaying a white image.

To solve the above problem, it is an object of the present invention to provide a liquid crystal display device that can reduce ineffective areas, in which liquid crystals do not rotate, as well as enhance the drive responsiveness of the liquid crystals.

The above-mentioned and other objects and novel features of the present invention will be apparent from the following description and the accompanying drawings.

A liquid crystal display device according to an aspect of the present invention includes two substrates sandwiching liquid crystals, and first and second electrodes formed in one of the two substrates. The first electrode is one of a pixel electrode and a common electrode. The second electrode is the other of the pixel electrode and the common electrode. The first electrode has, in each pixel, first and second portions extending in a first direction and spaced in a second direction orthogonal to the first direction. The first portion has two opposite edges inclined to the first direction so that the width of the first portion gradually decreases toward one side in the first direction. The second portion has two opposite edges inclined to the first direction so that the width of the second portion gradually increases toward the one side in the first direction.

In the liquid crystal display device according to the aspect, the width of each pixel in the first direction may be greater than the width of the pixel in the second direction.

In the liquid crystal display device according to the aspect, the first electrode may further have a common base portion in one side edge of each pixel, and each of the first and second portions may extend from the common base portion to the other side edge of the pixel.

In the liquid crystal display device according to the aspect, the first electrode may further has, in each pixel, third and fourth portions extending in the first direction and spaced in the second direction, the third portion, positioned in the one side in the first direction with respect to the first portion, may have two opposite edges inclined to the first direction so that the width of the third portion gradually increases toward the one side in the first direction, and the fourth portion, positioned in the one side in the first direction with respect to the second portion, may have two opposite edges inclined to the first direction so that the width of the fourth portion gradually decreases toward the one side in the first direction.

In the liquid crystal display device according to the aspect, the first electrode may have a space between the first and third portions and/or between the second and fourth portions.

In the liquid crystal display device according to the aspect, the third portion may be joined to the first portion, and the fourth portion may be joined to the second portion.

In the liquid crystal display device according to the aspect, an end of two edges of at least one of the first, second, third, and fourth portions of the first electrode may be inclined to the first direction at an angle greater than the inclination angle of the other part of the two edges with respect to the first direction.

In the liquid crystal display device according to the aspect, the liquid crystal display device may have, in each pixel, a first area in which the liquid crystals rotate clockwise and a second area in which the liquid crystals rotate counterclockwise, in a plan view, the first electrode may have a portion positioned between the first area and the second area, and a contact hole for coupling a TFT and the first electrode may be in the portion positioned between the first area and the second area.

An aspect of the present invention provides a liquid crystal display device that can reduce ineffective areas, in which liquid crystals do not rotate, as well as enhance the drive responsiveness of the liquid crystals.

### BRIEF DESCRIPTION OF THE DRAWINGS

FIG. 1 is a perspective view of a liquid crystal display device according to a first embodiment of the present invention;

FIG. 2 is a partial enlarged view of a portion of a pixel area of the liquid crystal display device according to the first embodiment of the present invention;

FIG. 3 is a cross-sectional view of a pixel of the liquid crystal display device taken along the cross-sectional line III-III in FIG. 2;

FIG. 4A is a schematic diagram explaining a first electrode to which no voltage is being applied and an arrangement of liquid crystal molecules, in the liquid crystal display device according to the first embodiment of the present invention;

FIG. 4B is a schematic diagram explaining the first electrode to which voltage is being applied and an arrangement of the liquid crystal molecules, in the liquid crystal display device according to the first embodiment of the present invention;

FIG. 5 is a schematic diagram explaining a first electrode to which voltage is being applied and an arrangement of liquid crystal molecules, in a liquid crystal display device whose first electrode is different from that in the first embodiment;

FIG. 6 is a partial enlarged view of a portion of a pixel area of a liquid crystal display device according to a second embodiment of the present invention;

FIG. 7 is a partial enlarged view of a portion of a pixel area of a liquid crystal display device according to a third embodiment of the present invention;

FIG. 8 is a partial enlarged view of a portion of a pixel area of a liquid crystal display device according to a fourth embodiment of the present invention;

FIG. 9 is a partial enlarged view of a portion of a pixel area of a liquid crystal display device according to a fifth embodiment of the present invention; and

FIG. 10 is a partial enlarged view of a portion of a pixel area of a liquid crystal display device according to a sixth embodiment of the present invention.

### DETAILED DESCRIPTION OF THE INVENTION

### First Embodiment

A liquid crystal display device according to a first embodiment of the present invention includes two substrates sandwiching liquid crystals, and first and second electrodes formed in one of the two substrates. The first electrode is one of a pixel electrode and a common electrode. The second electrode is the other of the pixel electrode and the common electrode. The first electrode has, in each pixel, first and second portions extending in a first direction and spaced in a second direction orthogonal to the first direction. The first portion has two opposite edges inclined to the first direction so that the width of the first portion gradually decreases toward one side in the first direction. The second portion has two opposite edges inclined to the first direction so that the width of the second portion gradually increases toward the one side in the first direction.

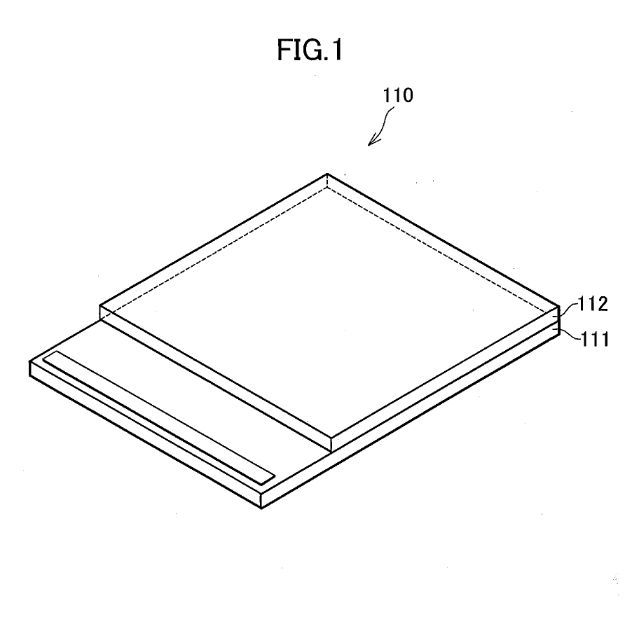

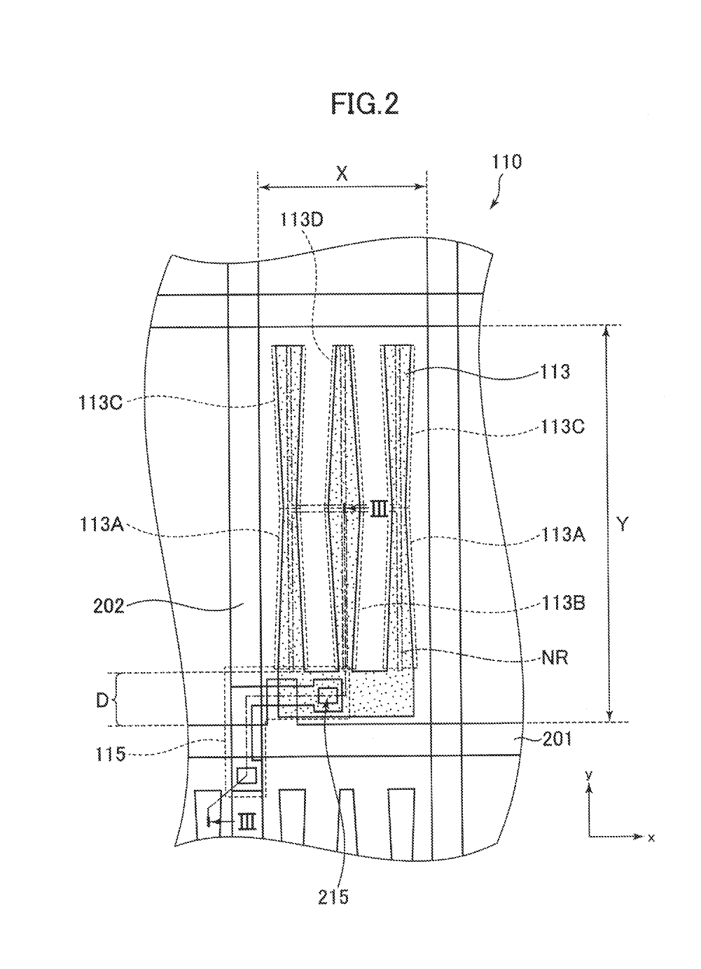

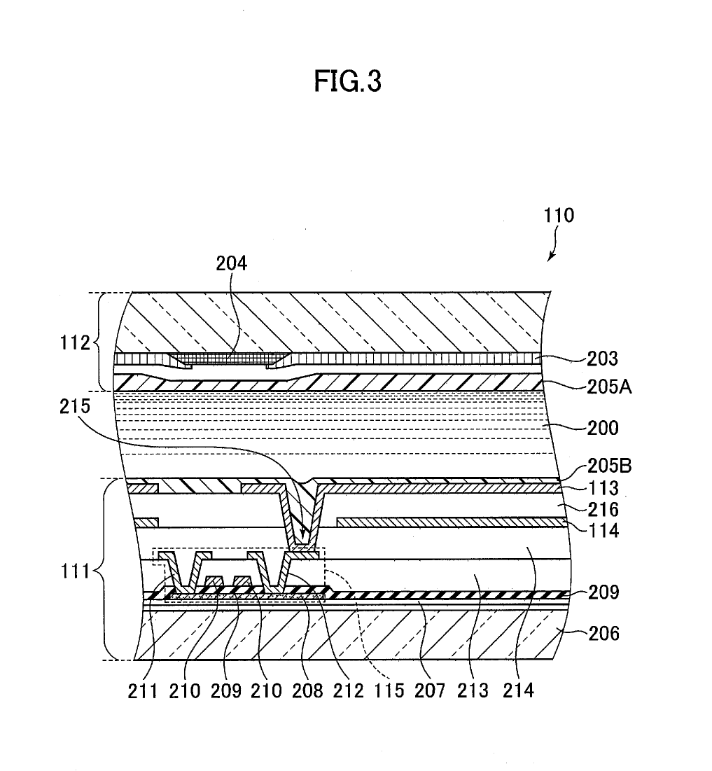

The liquid crystal display device according to this embodiment is described below with reference to the accompanying drawings. FIG. 1 is a perspective view of a liquid crystal display device 110 according to the first embodiment of the present invention. FIG. 2 is a partial enlarged view of a portion of a pixel area of the liquid crystal display device 110 according to the first embodiment of the present invention. FIG. 3 is a cross-sectional view of a pixel of the liquid crystal display device 110 taken along the cross-sectional line III-III in FIG. 2.

As shown in FIG. 1, the liquid crystal display device 110 in this embodiment includes two substrates, a TFT substrate 111 and a color filter substrate (a counter substrate) 112, sandwiching a liquid crystal layer (200 in FIG. 3, not shown in FIG. 1).

The liquid crystal display device 110 in this embodiment also includes first and second electrodes formed in one of the two substrates. The first electrode is one of a pixel electrode and a common electrode. The second electrode is the other of the pixel electrode and the common electrode.

The following description assumes that the first electrode is a pixel electrode 113, that the second electrode is a common electrode 114, and that the TFT substrate 111 includes both the pixel electrode 113 and the common electrode 114.

The liquid crystal display device 110 in this embodiment is, for example, an in-plane switching (IPS) liquid crystal display device. The partial enlarged view of FIG. 2 and the cross-sectional view of FIG. 3 each show a pixel of the IPS liquid crystal display device 110 in this embodiment. In the description herein, each of the areas enclosed by scan lines 201 and data lines 202 is defined as one pixel area.

As shown in FIGS. 2 and 3, the TFT substrate 111 of the liquid crystal display device 110 includes a switching element 115 (hereinafter, also referred to as a thin film transistor or a TFT) formed near the intersection of the scan line 201 and the data line 202. The TFT 115 is turned to the ON state in response to a gate signal supplied through the scan line 201 and thus allows a video signal supplied through the data line 202 to be written in the pixel electrode 113.

The pixel electrode 113 is formed in a comb-like shape to overlap with the common electrode 114. The potential difference between a video signal supplied to the pixel electrode 113 and a counter voltage supplied to the common electrode 114 can change the orientation of liquid crystal molecules to control the intensity of transmitted light. The common electrode 114 covers the entire area shown in FIG. 2.

The liquid crystal display device 110 in this embodiment has a cross-sectional structure shown in FIG. 3, and the TFT substrate 111 and the color filter substrate 112 are arranged to face each other. A liquid crystal material is sandwiched between the TFT substrate 111 and the color filter substrate 112.

A sealant (not shown) is applied on the margin of the TFT substrate 111 and the margin of the color filter substrate 112 to form a container with a narrow gap together with the TFT substrate 111 and the color filter substrate 112. The liquid crystal material is sealed between the TFT substrate 111 and the color filter substrate 112, that is, in the container.

The color filter substrate 112 includes color filters 203 formed for each of red (R), green (G) and blue (B), and a black matrix 204 formed along the boundary between the color filters 203 to block light. The color filter substrate 112 includes an alignment film 205A that is in contact with the liquid crystal layer 200 and controls the orientation of the liquid crystal molecules. The TFT substrate 111 also includes an alignment film 205B that is in contact with the liquid crystal layer 200 and controls the orientation of the liquid crystal molecules.

At least part of the TFT substrate 111 is made of, for example, a transparent glass and a resin. For example, the TFT substrate 111 includes a transparent glass substrate 206, an underlayer 207 formed on the glass substrate 206, and a semiconductor layer 208 made of a polysilicon film and formed on the underlayer 207.

The TFT substrate 111 further includes a gate insulating film 209 formed on the semiconductor layer 208 and gate electrodes 210 formed on the gate insulating film 209. The gate electrodes 210 are formed by part of the scan line 201 formed in the TFT substrate 111.

The scan line 201 is formed of a multilayer film including a layer mainly composed of chromium (Cr) or molybdenum (Mo), and a layer mainly composed of aluminum (Al). The side faces of the scan line 201 are inclined so that its line with gradually increases from the top toward the bottom near the TFT substrate 111. Although FIGS. 2 and 3 show such a transistor as has two gate electrodes 210, the TFT 115 is not limited to such a transistor.

A doped drain region and a doped source region are formed apart from each other in both edges of the semiconductor layer 208. Which of such doped regions should be called a drain or a source depends on how to apply potentials to the regions. In the description herein, the region coupled to the data line is referred to as a drain 211 and the region coupled to the pixel electrode 113 is referred to as a source 212.

The data line 202 is formed of a multilayer film including two layers mainly composed of an alloy of molybdenum (Mo) and chromium (Cr), and molybdenum (Mo) or tungsten (W), and a layer mainly composed of aluminum (Al) and sandwiched between the two layers. A first insulating film 213 and a second insulating film 214 are formed to cover the TFT 115. The source region is coupled to the pixel electrode 113 through a contact hole 215 formed in both the first insulating film 213 and the second insulating film 214.

The first insulating film 213 can be formed of an inorganic material containing silicon nitride or silicon oxide. The second insulating film 214 can be formed of an inorganic material or an organic material containing an organic resin film. The surface of the second insulating film 214 can be formed to be flat, but can be processed to form asperities.

The common electrode 114 is formed on the second insulating film 214. An insulating interlayer 216 is formed on the common electrode 114. The pixel electrode 113 is disposed on the insulating interlayer 216. Applying a grayscale voltage to the pixel electrode 113 causes a potential difference between the common electrode 114 and the pixel electrode 113. The common electrode 114, the insulating interlayer 216, and the pixel electrode 113 forms a capacitor element.

The pixel electrode 113 and the common electrode 114 are each formed of a transparent conductive film, which may include a light-transparent conductive layer, such as indium tin oxide (ITO), indium tin zinc oxide (ITZO), indium zinc oxide (IZO), zinc oxide (ZnO), stannous oxide (SnO), and indium oxide (In₂O₃).

As shown in FIG. 2, the pixel electrode 113 included in the liquid crystal display device 110 in this embodiment has first portions 113A and a second portion 113B that extend in a first direction (the y direction in FIG. 2) and are spaced in a second direction (the x direction in FIG. 2) orthogonal to the first direction. The pixel electrode 113 thus shaped is included in each pixel.

Also as shown in FIG. 2, the TFT 115 is included near an edge opposite to the first direction (the y direction in FIG. 2) of the pixel. The TFT 115 and the pixel electrode 113 are coupled together through the contact hole 215, which is included near the edge opposite to the first direction (the y direction in FIG. 2) of the pixel including the TFT 115.

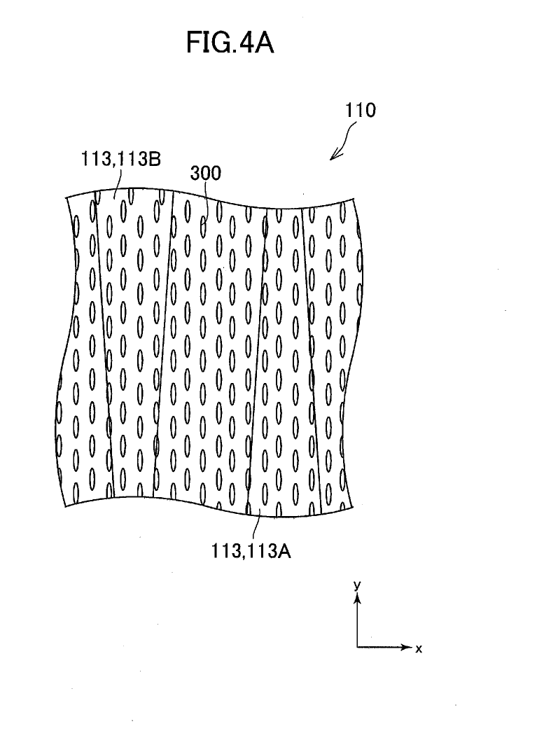

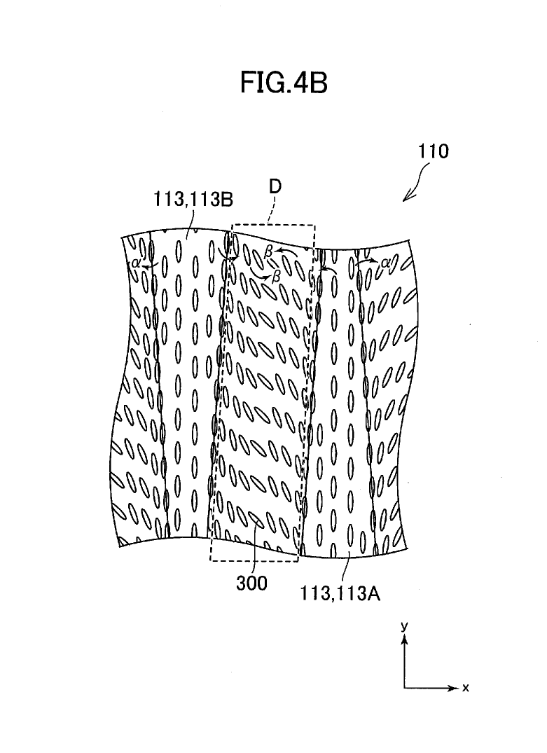

FIG. 4A is a schematic diagram explaining the first electrode to which no voltage is being applied and an arrangement of liquid crystal molecules, in the liquid crystal display device 110 according to the first embodiment of the present invention. FIG. 4B is a schematic diagram explaining the first electrode to which voltage is being applied and an arrangement of the liquid crystal molecules, in the liquid crystal display device 110 according to the first embodiment of the present invention.

As shown in FIG. 4A, liquid crystal molecules 300 constituting the liquid crystal material in the liquid crystal display device 110 in this embodiment is sealed to be oriented along the direction (the y diagram in FIG. 4A) in which the pixel electrode 113 (first electrode) extends. That is, the rubbing direction of the alignment films 205A and 205B is identical to the direction (the y direction in FIG. 4A) along the direction in which the pixel electrode 113 (first electrode) extends.

The edges of the pixel electrode 113 are inclined to the direction in which the pixel electrode 113 extends. Thus, the liquid crystal molecules 300 are arranged inclined to the edges of the pixel electrode 113. This inclination makes the distances of one end and the other end of each liquid crystal molecule 300 from the edges of the pixel electrode 113 different from each other. Consequently, the one end and the other end of each liquid crystal molecule 300 are differently affected by the pixel electrode 113 to which voltage is applied.

As shown in 4B, even while voltage is being applied to the pixel electrode 113, the voltages applied to the one end and the other end of each liquid crystal molecule 300 over the pixel electrode 113 are substantially the same. Thus, the liquid crystal molecules 300 over the pixel electrode 113 do not rotate in any direction in a plan view.

The liquid crystal molecules 300 over the pixel electrode 113, which do not rotate while voltage is being applied to the pixel electrode 113, do not act as shutters. Consequently, an area over the pixel electrode 113 in a normally-black liquid crystal display device, for example, becomes an ineffective area, which does not allow light from a backlight or the like to pass through it even while voltage is being applied to the pixel electrode 113.

On the other end, the one end and the other end of each liquid crystal molecule 300 not over the pixel electrode 113 in a plan view are differently affected by the pixel electrode 113 to which voltage is being applied. Thus, when voltage is applied to the pixel electrode 113, such an unbalance effect causes the liquid crystal molecule 300 not over the pixel electrode 113 to quickly rotate in a predetermined direction. In this embodiment, when voltage is applied to the pixel electrode 113, the liquid crystal molecules 300 not over the pixel electrode 113 rotate in the α or β direction shown in FIG. 4B.

As shown in FIGS. 4A and 4B, the pixel electrode 113 has the first portion 113A with edges inclined to the y direction so that the width of the first portion 113A gradually decreases upward in the y direction in the figures, and the second portion 113B with edges inclined to the y direction so that the width of the second portion 113B gradually increases upward in the y direction in the figures.

Also as shown in FIGS. 4A and 4B, the first portion 113A and the second portion 113B are spaced from each other in the x direction, which is orthogonal to the y direction. Alternatively, the first portion 113A and the second portion 113B may be arranged adjacent to each other in the x direction, which is orthogonal to the y direction.

The second portion 113B-side edge of the first portion 113A and the first portion 113A-side edge of the second portion 113B, which are adjacent to each other, may be arranged parallel or substantially parallel to each other.

It is preferable that the second portion 113B-side edge of the first portion 113A and the first portion 113A-side edge of the second portion 113B, which are adjacent to each other, be thus arranged parallel or substantially parallel to each other, because the voltage applied to the pixel electrode 113 causes the liquid crystal molecules 300 in an area between the first portion 113A and the second portion 113B to rotate more smoothly in the same direction.

In the liquid crystal display device 110 in this embodiment, the direction of rotation of the liquid crystal molecules 300 is reversed beyond the first portion 113A (and the second portion) of the pixel electrode 113 in the x direction shown in FIG. 2. Hereinafter, an area in which the direction of rotation of the liquid crystal molecules 300 is the same is referred to as an ordered area (domain D). It is preferable that the domain D be partitioned by shorter distances in the x direction shown in FIG. 2 in terms of enhancement of the response speed of the liquid crystal molecules 300 when voltage is applied to the pixel electrode 113.

For example, if the pixel electrode 113 has a come-like shape not with teeth whose width increases or decreases gradually as seen in the liquid crystal display device 110 in this embodiment, but with teeth of uniform width, the liquid crystal molecules 300 do not reverse the direction of rotation thereof at each of the teeth, but rotate in the same fixed direction in the pixel. Such shape is not preferable in terms of enhancement of the response speed of the liquid crystal molecules 300 when voltage is applied to the pixel electrode 113.

In the liquid crystal display device 110 in this embodiment, the direction of rotation of the liquid crystal molecules 300 is reversed beyond the first portion 113A (and the second portion) of the pixel electrode 113, and one pixel has a plurality of domains D. Thus, the liquid crystal display device 110 can enhance the response speed of the liquid crystal molecules 300, compared with a liquid crystal display device not having a come-shaped pixel electrode with teeth whose width increases or decreases gradually as seen in the liquid crystal display device 110 in this embodiment (a liquid crystal display device having a come-shaped pixel electrode with teeth of uniform width).

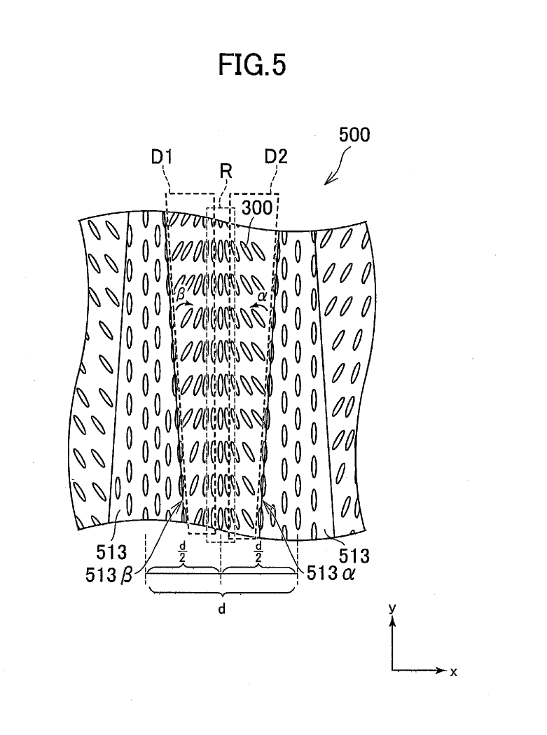

For reference, the following describes how the liquid crystal molecules 300 in a liquid crystal display device 500 having a first electrode whose shape is different from that in this embodiment moves while voltage is being applied to the first electrode. FIG. 5 is a schematic diagram explaining the first electrode to which voltage is being applied and an arrangement of the liquid crystal molecules 300, in the liquid crystal display device 500 whose first electrode is different from that in the first embodiment.

The first electrode (pixel electrode 513) of the liquid crystal display device 500 shown in FIG. 5 has two portions that extend in a first direction (the y direction in FIG. 5) and are spaced in a second direction (the x direction in FIG. 5) orthogonal to the first direction. These two portions each have two opposite edges inclined to the first direction so that the width of the portions gradually decreases upward in the first direction in FIG. 5.

For the liquid crystal display device 500 including the first electrode (pixel electrode 513) as shown in FIG. 5, the liquid crystal molecules 300 near an edge 513β in FIG. 5, which is one of the edges of the two portion adjacent to each other, rotate in the β direction while voltage is being applied to the first electrode. On the other hand, the liquid crystal molecules 300 near an edge 513α in FIG. 5, which is another of the edges of the two portion adjacent to each other, rotate in the α direction.

The liquid crystal display device 500 shown in FIG. 5 thus has two domains D1 and D2 between the two portions, and this is very advantageous in terms of enhancement of the response speed of the liquid crystal molecules 300 when voltage is applied to the first electrode.

However, in the liquid crystal display device 500 shown in FIG. 5, the liquid crystal molecules 300 that rotate in mutually opposite directions conflict with each other near the middle area (the area R enclosed by a dashed line in FIG. 5) between the two portions of the first electrode, which are adjacent to each other, and thus hinder themselves from moving. This means that the middle area (the area R enclosed by the dashed line in FIG. 5) between the two portions of the pixel electrode 513 is an ineffective area, which cannot act as shutters.

In contrast, in the liquid crystal display device 110, the middle area between the first portion 113A and the second portion 113B of the pixel electrode 113 shown in FIGS. 4A and 4B, which are adjacent to each other, does not become such an ineffective area. Thus, the liquid crystal display device 110 can enhance the transmittance, whereas it is slightly inferior in the response speed to the liquid crystal display device 500 shown in FIG. 5.

As shown in FIG. 2, the pixel electrode 113 of the liquid crystal display device 110 according to this embodiment may have at least one first portion 113A and at least one second portion 113B, except for a combination one first portion 113A and one second portion 113B, which alternate with each other.

Specifically, as shown in FIG. 2, the pixel electrode 113 of the liquid crystal display device 110 according to this embodiment has two first portion 113A and one second portion 114 that alternate with each other.

For example, the pixel electrode 113 of the liquid crystal display device 110 according to this embodiment may have one or two first portions 113A and one or two second portions 113B, except for a combination one first portion 113A and one second portion 113B, which alternate with each other. Alternately, the pixel electrode 113 may have two or three first portions 113A and two or three second portions 113B, except for a combination two first portions 113A and two second portions 113B, which alternate with each other.

The pixel electrode 113 thus formed makes one domain D (ordered distance) smaller, and thus can enhance the response speed of the liquid crystal molecules 300 when voltage is applied to the pixel electrode 113.

As shown in FIG. 2, the y-direction width Y of each pixel of the liquid crystal display device 110 in this embodiment may be greater than the x-direction width X. The pixel thus formed can reduce its horizontal width (width X in FIG. 2) without modifying the length of its comb teeth. Consequently, the liquid crystal display device 110 of higher definition can be produced. Moreover, the number of comb teeth of the pixel electrode 113 itself can be reduced, and accordingly ineffective areas can be reduced.

The pixel electrode 113 (first electrode) in this embodiment may have, in each pixel, a third portion 113C and a fourth portion 113D that extend in the first direction (the y direction in FIG. 2) and are spaced in the second direction (the x direction in FIG. 2) orthogonal to the first direction. The third portion 113C may be positioned in one side (the upper side in FIG. 2) of the first portion 113A in the first direction (the y direction in FIG. 2) and have two opposite edges inclined to the first direction (the y direction in FIG. 2) so that the width of third portion 113C gradually increases toward one side (upward in FIG. 2) in the first direction (the y direction in FIG. 2). The fourth portion 113D may be positioned in the one side (the upper side in FIG. 2) of the second portion 113B in the first direction (the y direction in FIG. 2) and have two opposite edges inclined to the first direction (the y direction in FIG. 2) so that the width of fourth portion 113D gradually decreases toward the one side (upward in FIG. 2) in the first direction (the y direction in FIG. 2).

The pixel electrode 113 thus formed causes the liquid crystal molecules 300 near one of the edges of the first portion 113A and the liquid crystal molecules 300 near the same side edge of the third portion 113C to rotate in mutually opposite directions while voltage is being applied to the pixel electrode 113. Thus, even when the pixel electrode 113 has long comb teeth, the domain D can be divided in the direction (the y direction in FIG. 2) in which the pixel electrode 113 extends, and the response speed of the liquid crystal molecules 300 in the pixel can be further enhanced.

It is known that a pixel electrode with comb teeth longer than a certain length typically reduces the rotatory power of the liquid crystal molecules 300 near the end of the comb teeth while voltage is being applied to a pixel electrode. As shown in FIG. 2, however, the pixel electrode 113 employing a shape that joins the first portion 113A and the third portion 113C together in its comb teeth can the longitudinal length of the comb teeth.

In such a manner, the liquid crystal display device 110 according to this embodiment may have the third portion 113C and the first portion 113A joined together, and the fourth portion 113D and the second portion 113B joined together.

For example, the longitudinal length of the first portion 113A and the second portion 113B of the pixel electrode 113 in this embodiment may be 50 μm or less, 40 μm or less, or 30 μm or less. The lower limit of the longitudinal length of the first portion 113A and the second portion 113B of the pixel electrode 113 in this embodiment is not particularly fixed, but may be, for example, 20 μm or more.

Similarly, the longitudinal length of the third portion 113C and the fourth portion 113D of the pixel electrode 113 in this embodiment may be 50 μm or less, 40 μm or less, or 30 μm or less. The lower limit of the longitudinal length of the third portion 113C and the fourth portion 113D of the pixel electrode 113 of the liquid crystal display device 110 in this embodiment is not particularly fixed, but may be, for example, 20 μm or more.

The y-direction (longitudinal direction) width Y, shown in FIG. 2, of each pixel of the liquid crystal display device 110 in this embodiment may be 100 μm or less, 80 μm or less, or 60 μm or less.

The area NR enclosed by the two-dot chain line in FIG. 2 is an area (ineffective area), in which the liquid crystal molecules 300 do not rotate even while voltage is being applied to the pixel electrode 113.

That is, portions each of which is near the middle of the comb teeth of the first electrode (pixel electrode 113) and also extends along the first direction (the y direction in FIG. 2), and a portion extending along the second direction (the x direction in FIG. 2) from the middle between the first portion 113A and the third portion 113C of the first electrode (pixel electrode 113) to the middle between the second portion 113B and the fourth portion 113D of the first electrode (pixel electrode 113) are each the ineffective area in the liquid crystal display device 110 in this embodiment.

### Second Embodiment

A liquid crystal display device 120 according to a second embodiment of the present invention has the same arrangement as the liquid crystal display device 110 according to the first embodiment, except for the shape of the first electrode (pixel electrode). The following describes in detail a first electrode (pixel electrode 123) of the liquid crystal display device 120 according to the second embodiment.

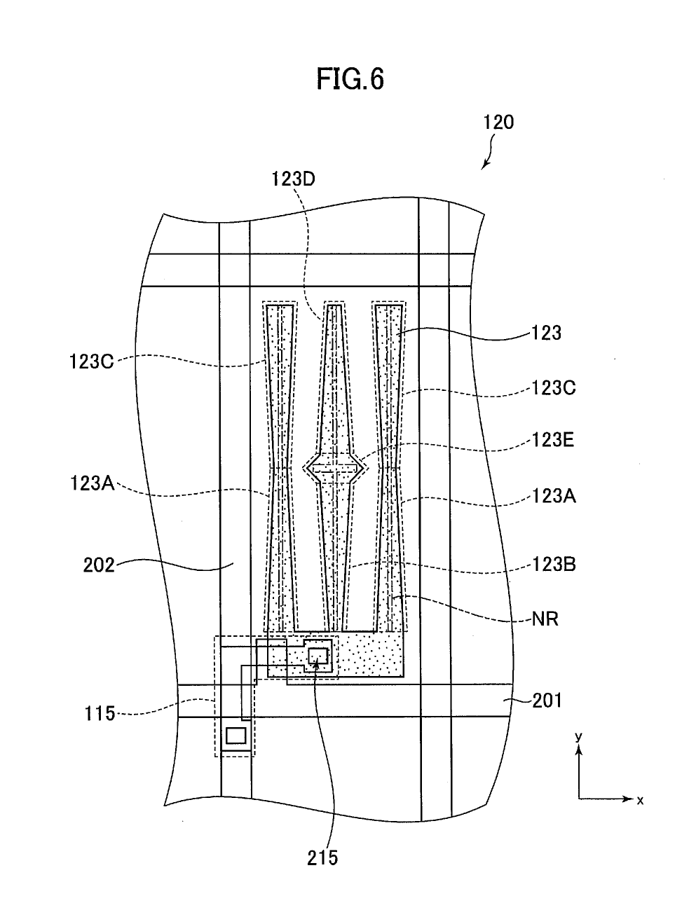

FIG. 6 is a partial enlarged view of a portion of a pixel area of the liquid crystal display device 120 according to the second embodiment of the present invention. As shown in FIG. 6, the first electrode (pixel electrode 123) of the liquid crystal display device 120 in the second embodiment has a second portion 123B and a fourth portion 123D, and further has a fifth portion 123E joining the second portion 123B and the fourth portion 123D together. The second portion 123B has two edges inclined to a first direction (the y direction in FIG. 6) so that the width of the second portion 123B gradually increases toward one side (upward in FIG. 6) in the first direction. The fourth portion 123D is positioned in one side (the upper side in FIG. 6) of the second portion 123B in the first direction and has two edges inclined to the first direction so that the width of the fourth portion 123D gradually decreases toward the one side in the first direction.

The second portion 123B-side half of the fifth portion 123E has two edges more greatly inclined to the first direction than the edges of the second portion 123B so that the width of the half gradually decreases toward the second portion 123B. The fourth portion 123D-side half of the fifth portion 123E has two edges more greatly inclined to the first direction than the edges of the fourth portion 123D so that the width of the half gradually decreases toward the fourth portion 123D.

The liquid crystal molecules 300 near the fifth portion 123E is more strongly affected by an electric field than the liquid crystal molecules 300s near the first portion 123A, the second portion 123B, the third portion 123C, and the fourth portion 123D, and thus rotate smoothly. This smooth rotation removes the ineffective area near the fifth portion 123E.

That is, the first electrode (pixel electrode 123) thus shaped, having the fifth portion 123E, reduces the ineffective area in a portion extending along a second direction (the x direction in FIG. 6) from the middle between the first portion 123A and the third portion 123C of the first electrode (pixel electrode 123) to the middle between the second portion 123B and the fourth portion 123D of the first electrode (pixel electrode 123).

The areas NR enclosed by the two-dot chain lines in FIG. 6 are each an area (ineffective area), in which the liquid crystal molecules 300 do not rotate even while voltage is being applied to the pixel electrode 123. That is, the ineffective areas in the liquid crystal display device 120 in this embodiment are limited to portions each of which is near the middle of the comb teeth of the first electrode (pixel electrode) and also extends along the first direction (the y direction in FIG. 6) and a portion near the middle of the fifth portion 123E.

Compared to the ineffective area shown in FIG. 2 (the area NR enclosed by the two-dot chain line in FIG. 2), it can be seen that the ineffective area in the portion extending along the second direction (the x direction in FIG. 6) from the middle between the first portion 123A and the third portion 123C of the first electrode (pixel electrode 123) to the middle between the second portion 123B and the fourth portion 123D of the first electrode (pixel electrode 123) is partly removed in the liquid crystal display device 120 according to this embodiment.

### Third Embodiment

A liquid crystal display device 130 according to a third embodiment of the present invention has the same arrangement as the liquid crystal display device 110 according to the first embodiment, except for the shape of the first electrode (pixel electrode). The following describes in detail a first electrode (pixel electrode 133) of the liquid crystal display device 130 according to the third embodiment.

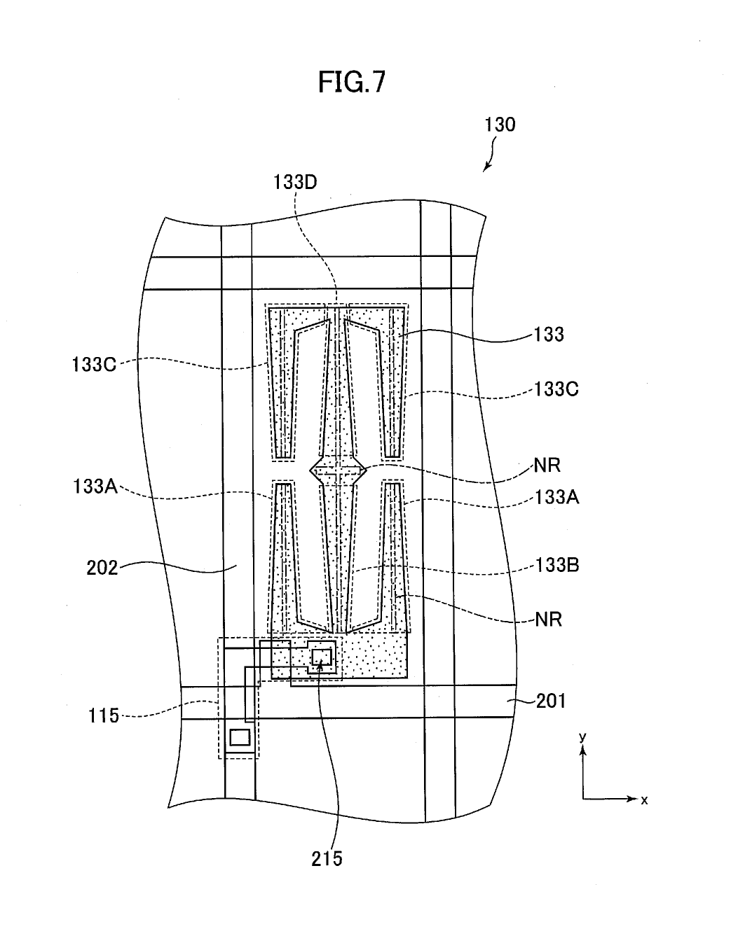

FIG. 7 is a partial enlarged view of a portion of a pixel area of the liquid crystal display device 130 according to the third embodiment of the present invention. The first electrode (pixel electrode 133) of the liquid crystal display device 130 according to the third embodiment has a space between a first portion 133A and a third portion 133C and/or between a second portion 133B and a fourth portion 133D.

In the first electrode (pixel electrode 133) of the liquid crystal display device 130 according to the third embodiment shown in FIG. 7, the first portion 133A and the third portion 133C are spaced from each other, and the second portion 133B and the fourth portion 133D are also spaced from each other.

For example, the first portion 133A and the third portion 133C that are not joined to each other but separated from each other make the liquid crystal molecules 300 between the first portion 133A and the third portion 133C in a plan view likely to rotate while voltage is being applied to the pixel electrode 133, and consequently can enhance the responsiveness.

An end of two edges that at least one of the first portion 133A, the second portion 133B, the third portion 133C, and the fourth portion 133D of the first electrode (pixel electrode 133) has may be inclined to the first direction (the y direction in FIG. 7) at an angle greater than the inclination angle of the other part of the two edges with respect to the first direction.

Thus, adjusting the inclination angle of part of the pixel electrode 133, near which the liquid crystal molecules 300 are less likely to rotate, can make the liquid crystal molecules 300 likely to rotate, and consequently can enhance the responsiveness.

In this embodiment, as shown in FIG. 7, an end of two edges of the first portion 133A is inclined at an angle greater than that of the other part of the two edges, and an end of two edges of the third portion 133C is inclined at an angle greater than that of the other part of the two edges.

Similarly, in this embodiment, as shown in FIG. 7, an end of two edges of the second portion 133B is inclined at an angle greater than that of the other part of the two edges, and an end of two edges of the fourth portion 133D is inclined at an angle greater than that of the other part of the two edges.

### Fourth Embodiment

A liquid crystal display device 140 according to a fourth embodiment of the present invention differs from the liquid crystal display device 110 according to the first embodiment in the shape of the first electrode (pixel electrode) and the position of the contact hole 215 for coupling the pixel electrode and the TFT 115 together. The other elements are the same as those of the liquid crystal display device 110 according to the first embodiment, and thus are not described herein. A first electrode (pixel electrode 143) of the liquid crystal display device 140 according to the fourth embodiment will be first described in detail.

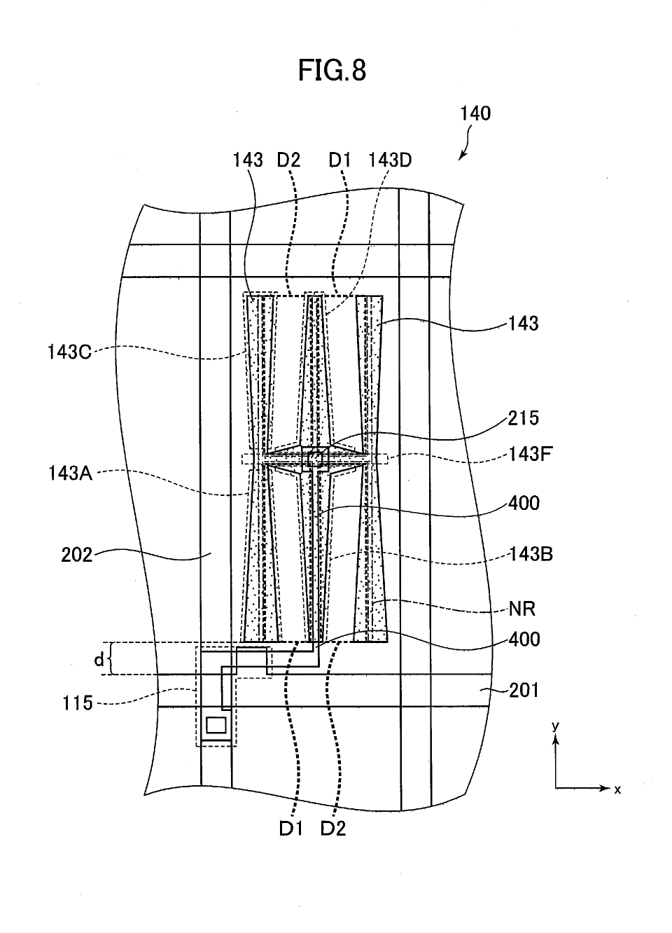

FIG. 8 is a partial enlarged view of a portion of a pixel area of the liquid crystal display device 140 according to the fourth embodiment of the present invention. As shown in FIG. 8, the liquid crystal display device 140 according to this embodiment has, in each pixel, a first area D1 in which liquid crystal molecules rotate clockwise and a second area D2 in which the liquid crystal molecules rotate counterclockwise, in a plan view. The first electrode (pixel electrode 143) has a portion positioned between the first area D1 and the second area D2, and the contact hole 215, formed in the portion positioned between the first area D1 and the second area D2, for coupling the TFT 115 and the first electrode (pixel electrode 143) together.

The portion positioned between the first area D1 and the second area D2 may be a joint 143F that joins a first portion 143A and a third portion 143C of the pixel electrode 143, and/or joins a second portion 143B and a fourth portion 143D of the pixel electrode 143. The TFT 115 of the liquid crystal display device 140 according to this embodiment may be positioned in a corner of the pixel, and the joint 143F joining the first portion 143A and the third portion 143C of the pixel electrode 143 may be positioned in the middle between the first portion 143A and the third portion 143C. The joint 143F joining the second portion 143B and the fourth portion 143D of the pixel electrode 143 may be positioned in the middle between the second portion 143B and the fourth portion 143D.

Such an arrangement allows the pixel electrode 143 to cover the region of the TFT 115 included in the corner of the pixel with a smaller portion thereof. For example, the TFT region of the liquid crystal display device 110 according to the first embodiment requires a space to form the contact hole 215 for coupling the TFT 115 and the pixel electrode 113, that is, an area with the first-direction (y-direction) width D as shown in FIG. 2. Accordingly, the pixel electrode 113 needs to have a large portion to cover the region of the TFT 115.

On the other hand, in the liquid crystal display device 140 according to this embodiment, the TFT 115 and the pixel electrode 143 are coupled together outside the TFT region. Thus, the pixel electrode 143 does not need to have a large portion to form the contact hole 215 for coupling the TFT 115 and the pixel electrode 143 within the region including the TFT.

Consequently, as shown in FIG. 8, the TFT region of the liquid crystal display device 140 in the fourth embodiment have only to secure an area with the first-direction (y-direction) width d, and the pixel electrode 143 covers the TFT region with a smaller portion than the pixel electrode in the liquid crystal display device having the contact hole 215 within the TFT region.

Thus, the liquid crystal display device 140 in this embodiment, which makes the TFT region smaller, can increase effective areas that allow light from, for example, backlight to pass through them.

As shown in FIG. 8, the liquid crystal display device 140 according to this embodiment may include the contact hole 215 for coupling the TFT 115 and the pixel electrode 143, and a source line 400 coupling the contact hole 215 and the TFT 115 so that the contact hole 215 and the source line 400 are overlapped with the pixel electrode 143 in a plan view.

Also as shown in FIG. 8, the source line 400, which couples the contact hole 215 and the TFT 115, may be arranged to overlap with the ineffective area NR over the first electrode (pixel electrode 143) of the liquid crystal display device 140 in this embodiment.

Also as shown in FIG. 8, the contact hole 215 may be formed to overlap with the joint 143F, which is positioned between the first area D1 and the second area D2 in a plan view, of the pixel electrode 143.

When the source line 400 is formed of a material mainly composed of an alloy of molybdenum (Mo) and chromium (Cr), and molybdenum (Mo) or tungsten (W), the area in which the source line 400 is formed does not act as an effective area, which allows light to pass through it, because the material does not allow light to pass through it. Thus, overlapping the source line 400 and the ineffective area NR over the first electrode (pixel electrode 143) can make effective use of the pre-existent ineffective area, in which the liquid crystal molecules 300 do not rotate even while voltage is being applied to the pixel electrode 143.

### Fifth Embodiment

A liquid crystal display device 150 according to a fifth embodiment of the present invention has the same arrangement as the liquid crystal display device 110 according to the first embodiment, except for the shape of the first electrode (pixel electrode). The following describes in detail a first electrode (pixel electrode 153) of the liquid crystal display device 150 according to the fifth embodiment.

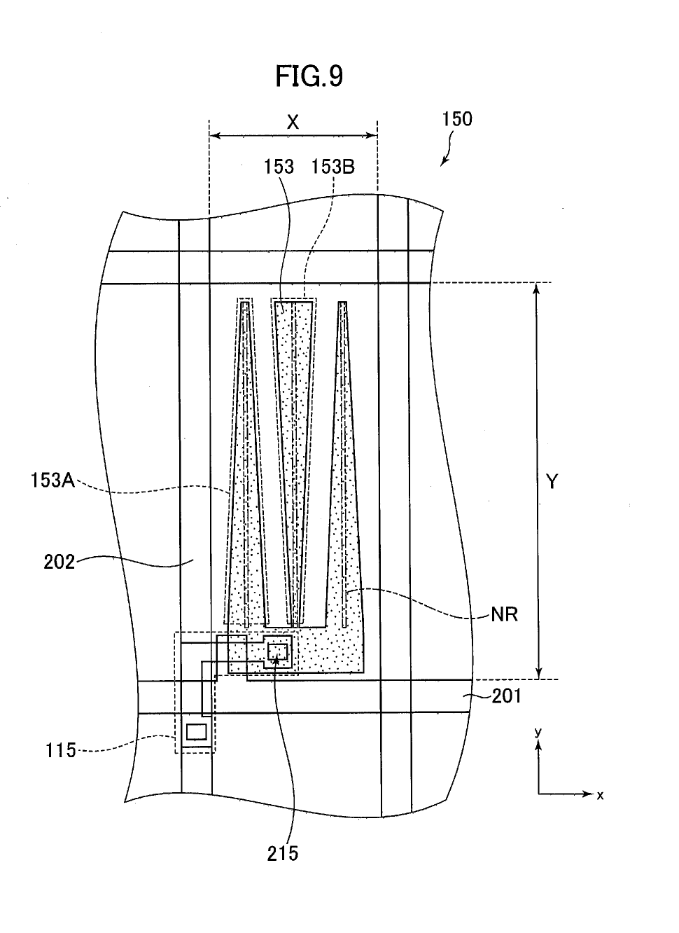

FIG. 9 is a partial enlarged view of a portion of a pixel area of the liquid crystal display device 150 according to a fifth embodiment of the present invention. The liquid crystal display device 150 in the fifth embodiment has a common base portion in one side edge of each pixel.

The first electrode (pixel electrode 153) of the liquid crystal display device 150 in the fifth embodiment has first portions 153A and a second portion 153B. Each of the first portions 153A has two opposite edges inclined to a first direction (the y direction in FIG. 9) so that the width of the first portion 153A gradually decreases toward one side in the first direction. The second portion 153B has two opposite edges inclined to the first direction (the y direction in FIG. 9) so that the width of the second portion 153B gradually increases toward the one side in the first direction. The first portions 153A and the second portion 153B each extend from the common base portion to the other side edge of each pixel.

That is, the first electrode (pixel electrode 153) of the liquid crystal display device 150 in this embodiment does not have the third portion (e.g., the third portion 113C in the first embodiment) and the fourth portion (e.g., the fourth portion 113D in the first embodiment) of the first electrode (pixel electrode) of the liquid crystal display devices in the above other embodiments.

The liquid crystal display device 150 in the fifth embodiment, which includes the above pixel electrode 153, can enhance the drive responsiveness of the liquid crystal molecules 300, reduce the ineffective areas NR, in which the liquid crystal molecules 300 do not rotate, and also reduce the pixel size. Consequently, high-definition liquid crystal display devices can be produced.

In this embodiment, the direction in which the first portions 153A and the second portion 153B of the first electrode (pixel electrode 153) extend is identical to the longitudinal direction of the pixel (Y in FIG. 9).

### Sixth Embodiment

A liquid crystal display device 160 according to a sixth embodiment of the present invention has the same arrangement as the liquid crystal display device 110 according to the first embodiment, except for the shape of the first electrode (pixel electrode). The following describes in detail a first electrode (pixel electrode 163) of the liquid crystal display device 160 according to the sixth embodiment.

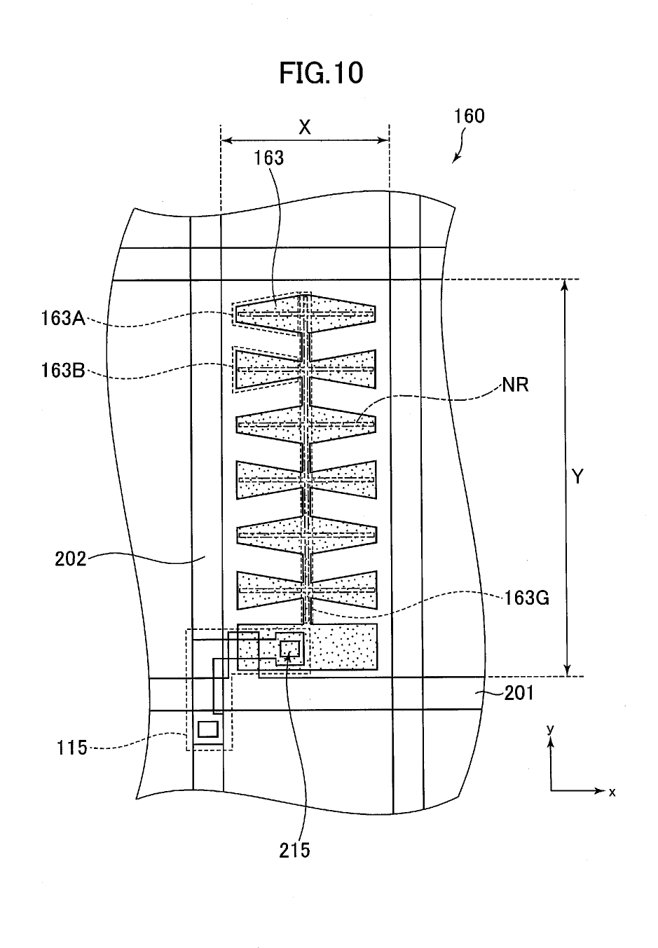

FIG. 10 is a partial enlarged view of a portion of a pixel area of the liquid crystal display device 160 according to the sixth embodiment of the present invention. The liquid crystal display device 160 in the sixth embodiment has a common base portion in one side edge of each pixel.

The first electrode (pixel electrode 163) of the liquid crystal display device 160 in the sixth embodiment has first portions 163A and second portions 163B. Each of the first portions 163A has two opposite edges inclined to a second direction (the x direction in FIG. 10) so that the width of the first portion 163A gradually increases toward one side in the second direction. Each of the second portions 163B has two opposite edges inclined to the second direction (the x direction in FIG. 10) so that the width of the second portion 163B gradually decreases toward the one side in the second direction. The first portions 163A and the second portions 163B are joined to an extension 163G extending from the common base portion in the first direction (the y direction in FIG. 10).

That is, in this embodiment, the direction in which the first portions 163A and the second portions 163B of the first electrode (pixel electrode 163) extend is identical to the transverse direction of the pixel (X in FIG. 10).

The liquid crystal display device 160 in the sixth embodiment, which includes the above pixel electrode 163, can enhance the drive responsiveness of the liquid crystal molecules 300 and also reduce ineffective areas, in which the liquid crystal molecules 300 do not rotate.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A liquid crystal display device comprising:
two substrates sandwiching liquid crystals;
a first electrode in one of the two substrates, the first electrode being one of a pixel electrode and a common electrode; and
a second electrode in the one substrate, the second electrode being the other of the pixel electrode and the common electrode, wherein
the first electrode has, in each pixel, first and second portions extending in a first direction and spaced in a second direction orthogonal to the first direction,
the first portion has two opposite edges inclined to the first direction so that a width of the first portion gradually decreases toward one side in the first direction, and
the second portion has two opposite edges inclined to the first direction so that a width of the second portion gradually increases toward the one side in the first direction.

2. The liquid crystal display device according to claim 1, wherein a width of each pixel in the first direction is greater than a width of the pixel in the second direction.

3. The liquid crystal display device according to claim 1, wherein
the first electrode further has a common base portion in one side edge of each pixel, and
each of the first and second portions extends from the common base portion to the other side edge of the pixel.

4. The liquid crystal display device according to claim 2, wherein
the first electrode further has, in each pixel, third and fourth portions extending in the first direction and spaced in the second direction,
the third portion, positioned in the one side in the first direction with respect to the first portion, has two opposite edges inclined to the first direction so that a width of the third portion gradually increases toward the one side in the first direction, and
the fourth portion, positioned in the one side in the first direction with respect to the second portion, has two opposite edges inclined to the first direction so that a width of the fourth portion gradually decreases toward the one side in the first direction.

5. The liquid crystal display device according to claim 4, wherein the first electrode has a space between the first and third portions and/or between the second and fourth portions.

6. The liquid crystal display device according to claim 4, wherein the third portion is joined to the first portion, and the fourth portion is joined to the second portion.

7. The liquid crystal display device according to claim 4, wherein an end of two edges of at least one of the first, second, third, and fourth portions of the first electrode is inclined to the first direction at an angle greater than an inclination angle of the other part of the two edges with respect to the first direction.

8. The liquid crystal display device according to claim 1, wherein
the liquid crystal display device has, in each pixel, a first area in which the liquid crystals rotate clockwise and a second area in which the liquid crystals rotate counterclockwise, in a plan view,
the first electrode has a portion positioned between the first area and the second area, and
a contact hole for coupling a TFT and the first electrode is in the portion positioned between the first area and the second area.
